(19) United States
(12) Patent Application Publication
(10) Pub. No.: US 2025/0298572 A1
(43) Pub. Date: Sep. 25, 2025

(54) PROVIDING INTERACTIVE CONTENT IN SCREEN SHARING

(71) Applicant: Microsoft Technology Licensing, LLC, Redmond, WA (US)

(72) Inventor: Wenlong YANG, Redmond, WA (US)

(21) Appl. No.: 18/863,965

(22) PCT Filed: May 15, 2023
(86) PCT No.: PCT/US2023/022196

§ 371 Date: Nov. 7, 2024

(30) Foreign Application Priority Data
Jun. 17, 2022 (CN) 202210691221.2

(51) Int. Cl. G06F 3/14; G06F 3/04842; G06F 40/20; H04L 65/401

(52) U.S. Cl. CPC G06F 3/1454; G06F 3/04842; G06F 40/20; H04L 65/4015

(57) ABSTRACT

The present disclosure proposes methods, apparatuses, computer program products and non-transitory computer-readable mediums for providing interactive content in screen sharing. In an aspect, a shared screen image corresponding to a source screen may be generated (510). At least one target object in the shared screen image may be determined, the at least one target object corresponding to at least one source content item in the source screen (520). At least one interactive content item corresponding to the at least one target object may be determined (530). Screen sharing data may be transmitted, the screen sharing data comprising at least the shared screen image and the at least one interactive content item (540). In another aspect, screen sharing data may be received. The shared screen image may be presented. The at least one interactive content item may be presented on the shared screen image based on the configuration parameters.

### BACKGROUND

Screen sharing function has been provided in various applications, e.g., online meeting application, video chatting application, etc. Through a screen sharing function, a user may show files, desktop, etc. to other users by sharing his local screen. For example, during conducting an online meeting through an online meeting application, a participant of the online meeting may enable a screen sharing function, so as to share a local screen as a screen sharing initiator. Accordingly, other participants of the online meeting, as recipients of screen sharing, may see a shared screen corresponding to the local screen of the screen sharing initiator on their respective user interfaces.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose methods, apparatuses, computer program products and non-transitory computer-readable mediums for providing interactive content in screen sharing. In an aspect, a shared screen image corresponding to a source screen may be generated. At least one target object in the shared screen image may be determined, the at least one target object corresponding to at least one source content item in the source screen. At least one interactive content item corresponding to the at least one target object may be determined. Screen sharing data may be transmitted, the screen sharing data comprising at least the shared screen image and the at least one interactive content item.

In another aspect, screen sharing data may be received, the screen sharing data comprising at least a shared screen image, at least one interactive content item corresponding to at least one target object in the shared screen image, and configuration parameters of the at least one interactive content item. The shared screen image may be presented. The at least one interactive content item may be presented on the shared screen image based on the configuration parameters. It should be noted that the above one or more aspects include the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in conjunction with the appended drawings that are provided to illustrate and not to limit the disclosed aspects.

FIG. 1 illustrates exemplary scenarios according to an embodiment.

FIG. 2 illustrates an exemplary process for providing interactive content in screen sharing according to an embodiment.

FIG. 3 illustrates an exemplary process for providing interactive content in screen sharing according to an embodiment.

FIG. 4 illustrates an example of providing interactive content in screen sharing according to an embodiment.

FIG. 5 illustrates a flowchart of an exemplary method for providing interactive content in screen sharing according to an embodiment.

FIG. 6 illustrates a flowchart of an exemplary method for providing interactive content in screen sharing according to an embodiment.

FIG. 7 illustrates an exemplary apparatus for providing interactive content in screen sharing according to an embodiment.

FIG. 8 illustrates an exemplary apparatus for providing interactive content in screen sharing according to an embodiment.

FIG. 9 illustrates an exemplary apparatus for providing interactive content in screen sharing according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

In the existing screen sharing function, a shared screen displayed on a user interface at the side of a screen sharing recipient is in a format of image. For example, the screen sharing function would convert a local screen at the side of a screen sharing initiator into a shared screen image, and display the shared screen image on the user interface at the side of the screen sharing recipient. Since the shared screen image is in a format of image, content contained in the shared screen image will be image objects or image elements in the shared screen image, and accordingly, the screen sharing recipient is unable to perform interaction operations such as clicking, copying, editing, etc. on these image objects. Assuming that a designated file is being displayed on the local screen of the screen sharing initiator, if the screen sharing recipient wants to perform interaction operations on specific content in the designated file displayed in the shared screen image, the screen sharing initiator would be usually required to send the whole designated file or the specific content in the designated file to the screen sharing recipient separately via, e.g., a chatting message in an application, an email, an instant communication tool message, etc.

Embodiments of the present disclosure propose mechanisms for providing interactive content in screen sharing. An application with a screen sharing function may enable a screen sharing recipient to perform content interaction during screen sharing, through the mechanisms proposed by the embodiments of the present disclosure. The mechanisms proposed by the embodiments of the present disclosure may be implemented by various applications having a screen sharing function, e.g., online meeting application, video chatting application, etc.

In an aspect, the embodiments of the present disclosure may not only send a shared screen image from the side of a screen sharing initiator to the side of a screen sharing recipient, but also send at least one interactive content item from the side of a screen sharing initiator to the side of a screen sharing recipient. The at least one interactive content item corresponds to at least one target object in the shared screen image, and may be presented together with the shared screen image on a user interface at the side of the screen sharing recipient. Herein, an interactive content item may refer to content in a format of text that supports various interaction operations, which may be, e.g., a text segment, a link, etc. Interaction operations supported by an interactive content item may include, e.g., clicking operation, copying operation, editing operation, and various other types of interaction operations. A target object corresponding to an interactive content item in a shared screen image is an image object or an image element in the shared screen image, and the target object corresponds to a source content item contained in a source screen on which screen sharing is performed. Herein, a source screen may refer to a local screen, at the side of a screen sharing initiator, on which screen sharing is performed, and a source content item may refer to content selected in the local screen by the screen sharing initiator and intended to be set such that a screen sharing recipient may perform interaction operations on it. A source content item may be in a format of text, e.g., a text segment, a link, etc., and a source content item may be formed by, e.g., characters, words, phrases, sentences, paragraphs, etc. Herein, a link may broadly refer to, e.g., a web address, an email address, a hyperlink, etc.

In an aspect, the embodiments of the present disclosure may enable a screen sharing initiator to select contents in a source screen which would be, as source content items, set as being operable by a screen sharing recipient, and only interactive content items corresponding to the selected source content items would be sent to the side of the screen sharing recipient. For example, a screen sharing initiator may select one or more source content items in a local screen or select all the contents contained in the local screen, as source content items. Accordingly, a screen sharing recipient can only perform interaction operations on the received interactive content items. Thus, data security of unselected source content items in a source screen may be effectively ensured. Moreover, the embodiments of the present disclosure may only send interactive content items corresponding to source content items currently displayed in the current source screen to the side of a screen sharing recipient, thereby, security of data that is not displayed in the current source screen may be effectively ensured.

In an aspect, the embodiments of the present disclosure may utilize a text box for presenting an interactive content item in a user interface at the side of a screen sharing recipient. For example, an interactive content item may be contained in a corresponding text box and presented with the text box. Preferably, the text box may be presented in an approach of covering a target object corresponding to the interactive content item in a shared screen image. Thus, the presentation of the interactive content item will not affect screen sharing visual experience of the screen sharing recipient.

In one aspect, the embodiments of the present disclosure propose multiple approaches of accurately and reliably determining an interactive content item corresponding to a target object in a shared screen image.

The embodiments of the present disclosure may achieve significant improvements to a screen sharing function in an application, enabling a screen sharing recipient to conveniently perform content interactions during screen sharing. The embodiments of the present disclosure may effectively avoid inconvenience and data security risks caused by that a screen sharing initiator directly provides a file or specific content in the file displayed on a source screen to a screen sharing recipient. Moreover, an interactive content item provided by the embodiments of the present disclosure may also be easily read by a screen reader. For example, when a screen sharing recipient needs to use an application having a screen sharing function with the aid of a screen reader, the screen reader may at least easily read a presented interactive content item so as to assist the screen share recipient to understand the content that is shared by a screen share initiator.

Herein, the term “application” may broadly refer to software, application program, application client, web application, widget, etc.

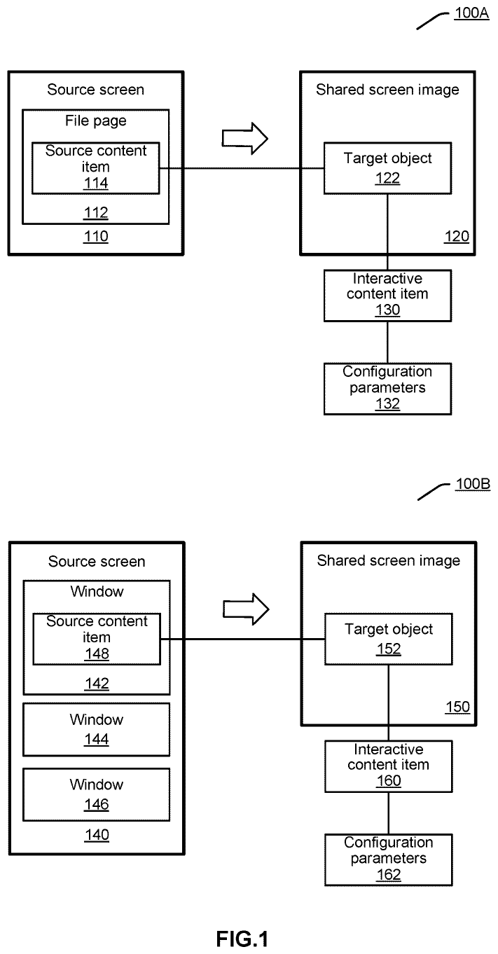

FIG. 1 illustrates exemplary scenarios according to an embodiment. Although for the ease of explanation, an example of taking an online meeting application as an application having a screen sharing function is adopted in FIG. 1, it should be understood that the embodiments of the present disclosure are not limited to an online meeting application, but may be applied to any other types of application having a screen sharing function.

Assuming that an online meeting is being conducted in the online meeting application, and a participant of the online meeting enables a screen sharing function, the participant would become a screen sharing initiator, and other participants of the online meeting would become screen sharing recipients. Moreover, for simplicity, hereinafter, a client of the online meeting application at the side of a screen sharing initiator is referred to as an initiator client, and a client of the online meeting application at the side of a screen sharing recipient is referred to as a recipient client.

Exemplary scenario 100A involves a situation where screen sharing is performed only for a designated file at the side of a screen sharing initiator. Accordingly, a source screen may refer to a local screen displaying a file page in the designated file. The following description takes the designated file being a slide file as an example.

It is assumed that when the screen sharing function is enabled, a slide application associated with the designated slide file has already been run on a terminal device of a screen sharing initiator, and the designated slide file has been opened in a user interface of the slide application. In response to that the screen sharing function is enabled and the screen sharing initiator designates the slide file for screen sharing, an initiator client may generate a corresponding shared screen image 120 for a current source screen 110 displaying an exemplary file page 112 in the designated slide file.

It is assumed that the screen sharing initiator selects an exemplary source content item 114 in the file page 112 in the source screen 110 to be set as being operable by a screen sharing recipient, wherein the source content item 114 may be, e.g., a text segment, a link, etc. The initiator client may determine a target object 122 in the shared screen image 120, which corresponds to the source content item 114. The target object 122 is an image object in the shared screen image 120, which corresponds to the source content item 114. The initiator client may further determine an interactive content item 130 corresponding to the target object 122. Accordingly, the interactive content item 130 also corresponds to the source content item 114. Optionally, the initiator client may also determine configuration parameters 132 of the interactive content item 130. The configuration parameters 132 may be used for indicating, e.g., how the interactive content item 130 will be presented at the side of a screen sharing recipient, what interaction property the interactive content item 130 will have, etc.

The initiator client may send screen sharing data to a recipient client. Screen sharing data is data related to presenting a shared screen image at the side of a screen sharing recipient. For example, the screen sharing data may include the shared screen image 120, the interactive content item 130, and the potential configuration parameters 132. The recipient client may present the received shared screen image 120 and interactive content item 130 on a user interface of the online meeting application at the side of the screen sharing recipient. Moreover, the recipient client may also present the interactive content item 130 based on the received configuration parameters 132, set interaction property of the interactive content item 130, etc. The screen sharing recipient may perform interaction operations on the interactive content item 130 presented on the user interface. If the interactive content item 130 is a text segment, interaction operations such as copying, editing, etc. may be performed on the interactive content item 130 according to the interaction property. If the interactive content item 130 is a link, interaction operations such as clicking, etc. may be performed on the interactive content item 130 according to the interaction property. A clicking operation on a link may trigger running of an application associated with the link. For example, in the case that the link is a web address, a clicking operation on the link could trigger accessing to the web address in a browser application; in the case that the link is an email address, a clicking operation on the link may trigger opening of an email editing page, in an email application, in which the email address is taken as a recipient; in the case that the link is a hyperlink, a clicking operation on the link may trigger opening of a corresponding page in an application associated with the hyperlink; and so on.

Exemplary scenario 100B involves a situation where screen sharing is performed for a desktop at the side of a screen sharing initiator. Accordingly, a source screen may refer to a local screen displaying the desktop.

A desktop at the side of a screen sharing initiator may refer to a desktop of an operating system or a user interface of an operating system at the side of the screen sharing initiator. The desktop may at least include one or more running windows, and each window may correspond to, e.g., a user interface of an application. It is assumed that when a screen sharing function is enabled, multiple exemplary windows have been running on a desktop at the side of a screen sharing initiator. The screen sharing initiator may make, through specific selecting or switching operations, one or more or all of these windows be displayed in a source screen on the desktop. As an example, it is assumed that a window 142, a window 144 and a window 146 are displayed in a current source screen 140. In response to that a screen sharing function is enabled and a screen sharing initiator selects that screen sharing will be performed for a desktop, an initiator client may generate a corresponding shared screen image 150 for the current source screen 140 displaying the windows 142 to 146.

It is assumed that the screen sharing initiator selects an exemplary source content item 148 in the window 142 in the source screen 140 to be set as being operable by a screen sharing recipient, wherein the source content item 148 may be, e.g., a text segment, a link, etc. As an example, the window 142 may correspond to a user interface of a slide application, and the source content item 148 may be selected from a slide file page being displayed in the user interface of the slide application. The initiator client may determine a target object 152, in the shared screen image 150, which corresponds to the source content item 148. The target object 152 is an image object, in the shared screen image 150, which corresponds to the source content item 148. The initiator client may further determine an interactive content item 160 corresponding to the target object 152. Accordingly, the interactive content item 160 also corresponds to the source content item 148. Optionally, the initiator client may also determine configuration parameters 162 of the interactive content item 160. The configuration parameters 162 may be used for indicating, e.g., how the interactive content item 160 will be presented at the side of a screen sharing recipient, what interaction property the interactive content item 160 will have, etc.

Similar to the scenario 100A, the initiator client may send screen sharing data including the shared screen image 150, the interactive content item 160, the potential configuration parameters 162, etc. to a recipient client. Similar to the scenario 100A, a recipient client may present the received shared screen image 150 and interactive content item 160 on a user interface of the online meeting application at the side of the screen sharing recipient, and may perform interaction operations on the interactive content item 160 presented on the user interface.

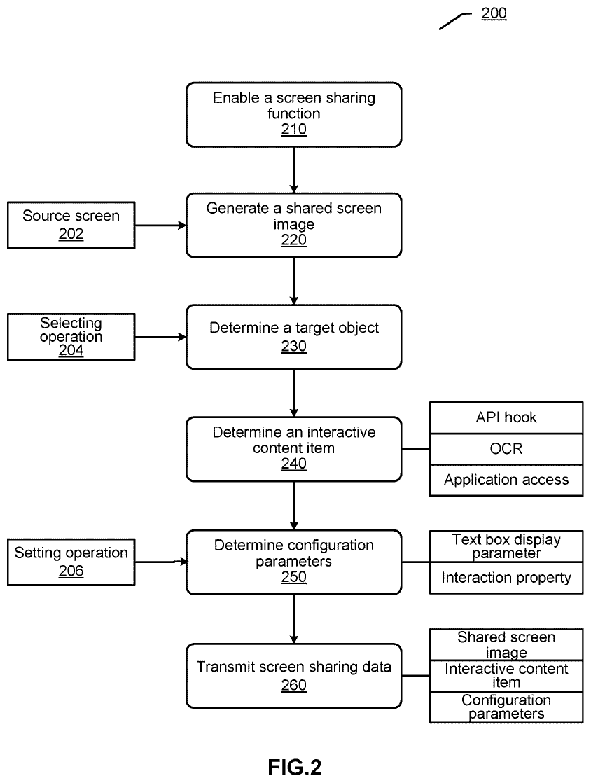

It should be understood that the above descriptions of the scenario 100A and scenario 100B are exemplary, and the embodiments of the present disclosure are not limited to be applied to these scenarios, but may also be applied to any variants of these scenarios or any other scenarios. For example, although only a single selected source content item 114 is involved in the scenario 100A and only a single selected source content item 148 is involved in the scenario 100B, the screen sharing initiator may also select multiple source content items in the source screen 110 or the source screen 140 or select all the contents in the source screen 110 or the source screen 140, as source content items, to be set as being operable by a screen sharing recipient. In this case, the initiator client may determine target objects and interactive content items respectively corresponding to these selected source content items, and determine configuration parameters respectively corresponding to these interactive content items, and a recipient client may present all of these interactive content items at the same time when presenting the shared screen image. FIG. 2 illustrates an exemplary process 200 for providing interactive content in screen sharing according to an embodiment. The process 200 may be performed by an application having a screen sharing function at the side of a screen sharing initiator.

At 210, a screen sharing function may be enabled in response to an indication from the screen sharing initiator. For example, the screen sharing initiator may send an instruction of enabling the screen sharing function, through clicking a specific button in a user interface of the application having the screen sharing function.

It is assumed that the screen sharing initiator wants to perform screen sharing on a source screen 202. At 220, a shared screen image corresponding to the source screen 202 may be generated. The shared screen image is visually consistent with the source screen 202, but it is in a format of image.

At 230, at least one target object may be determined from the shared screen image, wherein the at least one target object corresponds to at least one source content item in the source screen 202. The at least one source content item may be selected through a selecting operation 204 by the screen sharing initiator. For example, the screen sharing initiator may specify the at least one source content item in the source screen 202 in any approach, and indicate that the at least one source content item is intended to be set as being operable by a screen sharing recipient. The target object determination at 230 may include receiving the selecting operation 204 to the at least one source content item in the source screen 202 by the screen sharing initiator, and determining the at least one target object, in the shared screen image, corresponding to the at least one source content item based on the selecting operation 204. For example, since the shared screen image is visually consistent with the source screen 202, at least one image object having the same position as the at least one source content item may be identified from the shared screen image as the at least one target object. It should be understood that the selection of the at least one source content item by the screen sharing initiator may include selecting only one source content item from the source screen 202, selecting a plurality of source content items from the source screen 202, or selecting all the contents in the source screen 202 as source content items.

At 240, at least one interactive content item corresponding to the at least one target object may be determined. The interactive content item determination at 240 may be performed through multiple implementations.

In an implementation, the at least one source content item selected by the screen sharing initiator may be obtained through executing a predetermined code segment with an API hook, and the obtained at least one source content item may be taken as the at least one interactive content item.

In response to the selecting operation 204 to the at least one source content item in the source screen 202 by the screen sharing initiator, at least one rectangular region respectively covering the at least one source content item may be generated. For example, for each selected source content item, a rectangular region is generated. The API hook may be hung for all the rectangular regions. The API hook is added to a text display API in the operating system, and the API hook may be used for calling or jumping to the predetermined code segment. The predetermined code segment may refer to a code segment prepared in advance for acquiring characters, text, etc., by any approach.

For each rectangular region, a painting or refreshing event for a source content item within the rectangular region may be triggered. The painting or refreshing event is an event used for displaying or refreshing text. In response to the painting or refreshing event, the operating system will call the text display API. During the running of the text display API, the API hook added to the text display API will cause the predetermined code segment to be executed so as to obtain characters, text, etc., to be displayed, thus obtaining a source content item within the rectangular region. After completing the execution of the predetermined code segment, it may return to the text display API to continue execution.

The API hook may be updated timely. For example, if a source content item is changed or a new source screen is displayed, a previous API hook may be removed and a new API hook may be hung. Accordingly, a new source content item may be obtained through the process as described above.

The above API hook-based implementation may stably obtain source content items, thereby obtaining interactive content items.

In an implementation, at least one interactive content item may be obtained through performing optical character recognition (OCR) to the at least one target object determined at 230. A target object is an image object or image element in a shared screen image, therefore, characters, text, etc. displayed by the target object may be recognized through performing OCR on the target object, thus obtaining a corresponding interactive content item.

The above OCR-based implementation may perform an interactive content item obtaining operation with simple processing logic.

In an implementation, at least one source content item may be obtained through accessing an application associated with the selected at least one source content item, and the obtained at least one source content item may be taken as the at least one interactive content item.

An application associated with a source content item may refer to, e.g., an application associated with a file containing the source content item. As an example, assuming that a source content item is selected from a slide file page, an application associated with the source content item may be a slide application. An application having a screen sharing function may have an access right to the application associated with the source content item. The application associated with the source content item may provide a called API, so that the application having the screen sharing function may access the application associated with the source content item through the called API so as to obtain the at least one source content item selected in the source screen 202 by the screen sharing initiator. The obtained at least one source content item may be further taken as the at least one interactive content item.

The above application access-based implementation may directly access an application associated with a source content item to obtain a text segment, a link, etc. in the source content item, so as to obtain an interactive content item.

It should be understood that the embodiments of the present disclosure are not limited to performing the interactive content item determination at 240 through the several exemplary implementations as described above, but may cover any variants of these implementations and any other implementations.

In order to achieve better presentation effect and use experience of interactive content, the process 200 may optionally include determining configuration parameters of at least one interactive content item at 250.

In an aspect, the embodiments of the present disclosure may present an interactive content item with a text box at the side of a screen sharing recipient, e.g., an interactive content item may be contained in a corresponding text box, and thus, the interactive content item may be presented through presenting the text box. Accordingly, the configuration parameters may include, e.g., a display parameter of at least one text box corresponding to the at least one interactive content item determined at 240. Accordingly, the configuration parameter determination at 250 may include: determining a display parameter of at least one text box corresponding to at least one interactive content item. Each interactive content item may correspond to a text box, and accordingly, a text box display parameter may be determined for each interactive content item. A display parameter of a text box may include layout parameters of the text box, e.g., the width of the text box, the height of the text box, the position of the text box on the screen, etc. The display parameter of the text box may at least enable the text box to cover a corresponding target object. Moreover, the display parameter of the text box may further include character display parameters of the interactive content item, e.g., font, word size, color, etc. Preferably, the character display parameters of the interactive content item may be set such that the interactive content item is visually identical to a corresponding source content item. Moreover, optionally, the display parameter of the text box may further include display effect parameters of the text box, e.g., transparency, background color, background pattern, frame, etc. of the text box. Preferably, the text box may be presented with a transparent background, thus a screen sharing recipient may only visually see the interactive content item contained in the text box, but cannot realize the existence of the text box.

The embodiments of the present disclosure may determine a display parameter of a text box in various approaches. For example, layout parameters of a text box may be determined through identifying layout parameters of a target object in a shared screen image, or layout parameters of a text box may be determined according to layout parameters of a source content item obtained from an application associated with the source content item. For example, character display parameters of an interactive content item may be determined through identifying character display parameters of a target object in a shared screen image, or character display parameters of an interactive content item may be determined according to character display parameters of a source content item obtained from an application associated with the source content item. For example, display effect parameters of a text box may be determined according to default settings. It should be understood that the embodiments of the present disclosure are not limited to the exemplary approaches of determining a display parameter of a text box as described above.

In an aspect, the configuration parameters may include, e.g., an interaction property of the at least one interactive content item determined at 240. Accordingly, the configuration parameters determination at 250 may include: determining an interaction property of at least one interactive content item. Each interactive content item may have a corresponding interaction property. An interaction property of an interactive content item defines the types of interaction operation supported by the interactive content item. An interaction property may include, e.g., a clickable property, a copy property, an editable property, etc. A clicking operation may be performed on an interactive content item with a clickable property, a copying operation may be performed on an interactive content item with a copy property, and an editing operation may be performed on an interactive content item with an editable property. Each interactive content item may have different types of interaction property at the same time. Moreover, in the case that an interactive content item is a link such as a web address, an email address, a hyperlink, etc., if the interactive content item has a clickable property, a clicking operation performed on the interactive content item may trigger the running of an application associated with the link.

An interaction property of an interactive content item may be determined according to a setting operation 206 on an interaction property of a source content item by a screen sharing initiator. For example, after the screen sharing initiator selects the at least one source content item in the source screen 202 through the selecting operation 204, the screen sharing initiator may then set an interaction property in the source screen 202 for the selected at least one source content item. As an example, options for setting an interaction property may be added to, e.g., a mouse button popup menu (e.g., a right mouse button popup menu), so that after clicking a source content item with the right mouse button, the screen sharing initiator may select, from the right mouse button popup menu, one or more interaction properties desired to be set for the source content item. The screen sharing initiator may set an interaction property separately for each source content item. Optionally, the screen sharing initiator may also uniformly set an interaction property for multiple source content items. The setting operation 206 on the interaction property of the at least one source content item by the screen sharing initiator may be received, and the interaction property of the at least one interactive content item may be determined based on the setting operation 206. For example, for each interactive content item, an interaction property set for a source content item corresponding to the interactive content item may be taken as an interaction property of the interactive content item.

It should be understood that the embodiments of the present disclosure are not limited to the exemplary approach of determining an interaction property as described above.

At 260, screen sharing data may be transmitted. For example, the screen sharing data is transmitted from the side of the screen sharing initiator to the side of at least one screen sharing recipient. The screen sharing data may include at least the shared screen image generated at 220, the at least one interactive content item determined at 240, etc. If configuration parameters are determined at 250, the screen sharing data may further include the configuration parameters.

It should be understood that all the operations or steps in the process 200 as described above in connection with FIG. 2 are exemplary, and depending on specific application scenarios and requirements, the process 200 may include more or less operations or steps, and the embodiments of the present disclosure will cover any approaches of modification made to the process 200.

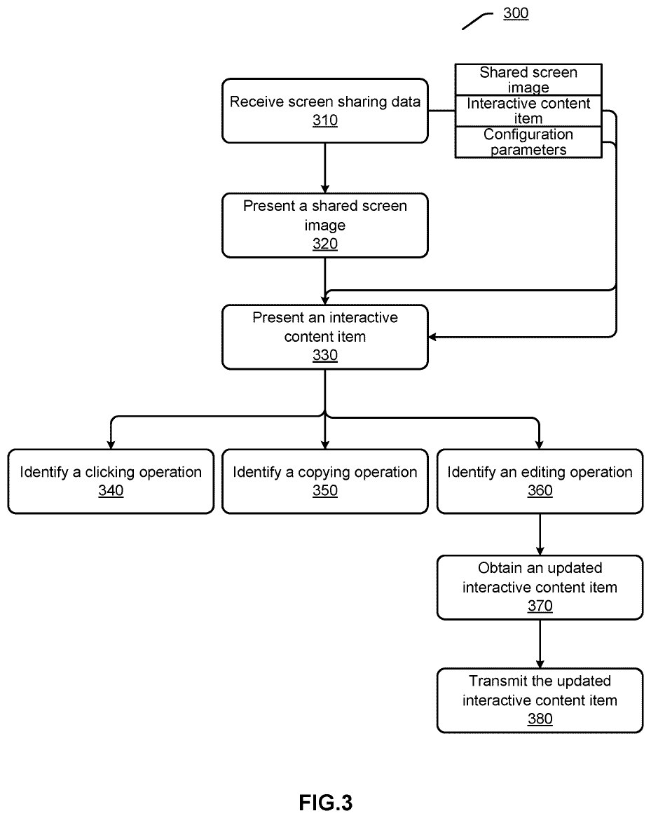

FIG. 3 illustrates an exemplary process 300 for providing interactive content in screen sharing according to an embodiment. The process 300 may be performed by an application having a screen sharing function at the side of a screen sharing recipient.

At 310, screen sharing data may be received. The screen sharing data may include at least a shared screen image, at least one interactive content item corresponding to at least one target object in the shared screen image, etc. Moreover, the screen sharing data may further include configuration parameters of the at least one interactive content item.

At 320, the shared screen image may be presented. For example, an application having a screen sharing function may render the received shared screen image in a user interface at the side of the screen sharing recipient through various known approaches.

At 330, the at least one interactive content item may be presented on the presented shared screen image. For example, an application having a screen sharing function may render the received at least one interactive content item in a user interface at the side of the screen sharing recipient through various known approaches. In the case that configuration parameters in the screen sharing data are received, the at least one interactive content item may be presented on the shared screen image based on the received configuration parameters. The configuration parameters may include a display parameter of at least one text box corresponding to the at least one interactive content item. Accordingly, the at least one text box may be presented on the shared screen image based on the display parameter of the at least one text box. The at least one text box contains the at least one interactive content item, and the at least one text box covers at least one corresponding target object in the shared screen image. For example, the display parameter of the text box may include layout parameters of the text box, thus the text box may be presented according to the layout parameters so as to enable the text box to cover a corresponding target object. For example, the display parameter of the text box may further include character display parameters of the interactive content item, thus the interactive content item contained in the text box may be rendered according to the character display parameters. Moreover, the display parameter of the text box may further include display effect parameters of the text box, thus the text box may be rendered according to the display effect parameters.

Moreover, the process 300 may also set a corresponding interaction property for the at least one interactive content item contained in the at least one text box. For example, the configuration parameters may include an interaction property of the at least one interactive content item, thus a corresponding interaction property may be set for each interactive content item according to the configuration parameters. Accordingly, each presented interactive content item may support interaction operations corresponding to its interaction property.

After the shared screen image and the at least one interactive content item have been presented, the screen sharing recipient may not only see the shared screen image, but also perform interaction operations on the at least one interactive content item. For example, a clicking operation is performed on an interactive content item with a clickable property, a copying operation is performed on an interactive content item with a copy property, an editing operation is performed on an interactive content item with an editable property, etc.

If the screen sharing recipient performs a clicking operation on an interactive content item with a clickable property, the clicking operation may be identified at 340. Optionally, the process 300 may further trigger an application associated with the interactive content item in response to the clicking operation. Exemplarily, the interactive content item may be a link, and accordingly, running of an application associated with the link may be triggered. For example, in the case that the link is a web address, running of a browser application may be triggered to access the web address; in the case that the link is an email address, running of an email application may be triggered to open an email editing page with taking the email address as a recipient; in the case that the link is a hyperlink, an application associated with the hyperlink may be triggered to open a corresponding page; and so on.

If the screen sharing recipient performs a copying operation on an interactive content item with a copy property, the copying operation may be identified at 350. The process 300 may further provide content to be copied in the interactive content item in response to the copying operation. Preferably, the process 300 may support collaborative editing operations. For an interactive content item with an editable property, if a specific screen sharing recipient performs an editing operation on the interactive content item, e.g., the specific screen sharing recipient performs an operation, such as character deletion, character addition, etc., on the interactive content item, the process 300 may handle this editing operation in a collaborative approach. At 360, the editing operation may be identified. At 370, an updated interactive content item generated through the editing operation on the interactive content item may be obtained. At 380, the updated interactive content item may be transmitted, e.g., broadcasting or synchronizing the updated interactive content item to the side of the screen sharing initiator and the side of other screen sharing recipients. In an aspect, in the case that an application having a screen sharing function has an access right to an application associated with the source content item, the updated interactive content item may be displayed directly in the source screen to replace the corresponding source content item, so that the screen sharing initiator may learn about the editing operation performed by the screen sharing recipient. In another aspect, at the side of other screen sharing recipients, the updated interactive content item may directly replace the previous interactive content item, so that other screen sharing recipients may learn about the editing operation performed by the specific screen sharing recipient.

It should be understood that all the operations or steps in the process 300 as described above in connection with FIG. 3 are exemplary, and depending on specific application scenarios and requirements, the process 300 may include more or less operations or steps, and the embodiments of the present disclosure will cover any approaches of modification made to the process 300.

Moreover, it should be understood that the performing of the process 200 in FIG. 2 and the process 300 in FIG. 3 may be triggered in response to an update of a source screen. For example, during screen sharing, whenever a new source screen appears due to updating or changing of a source screen, the process 200 in FIG. 2 and the process 300 in FIG. 3 will be triggered to be performed for the new source screen.

Moreover, it should be understood that the mechanisms proposed by the embodiments of the present disclosure for screen sharing may also broadly cover the situation of video sharing. The process of screen sharing may be understood as, e.g., continuously capturing a local screen of a screen sharing initiator to obtain a source screen sequence, forming a video stream containing a shared screen image sequence based on the source screen sequence, and transmitting the video stream to the side of a screen sharing recipient. That is, the process of screen sharing may correspond to a process of sharing a video stream involving a screen. Thus, the embodiments of the present disclosure may be applied, in an approach similar to that as described above, to a video sharing process which shares any type of video stream. Accordingly, the embodiments of the present disclosure may provide an interactive content item for a video during such video sharing process, and enable a recipient who receives the shared video to perform interaction operations on the interactive content item presented along with the video.

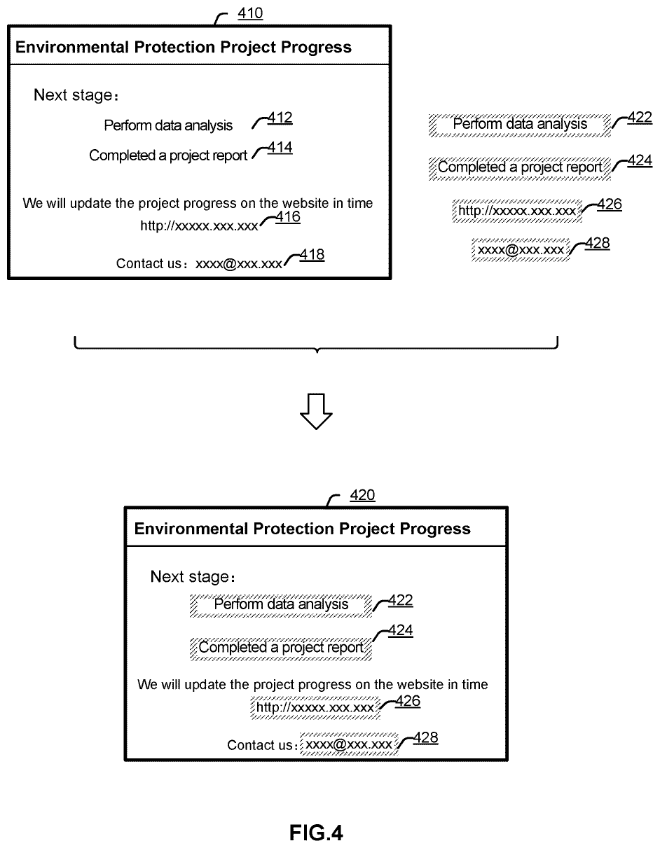

FIG. 4 illustrates an example of providing interactive content in screen sharing according to an embodiment.

It is assumed that a shared screen image 410 is received on the side of a screen sharing recipient. The shared screen image 410 includes at least a target object 412, a target object 414, a target object 416, a target object 418, etc., in a format of image. The target object 412 corresponds to a source content item “Perform data analysis” of a text segment type selected in a shared source screen. The target object 414 corresponds to a source content item “Complete a project report” of a text segment type selected in the shared source screen. The target object 416 corresponds to a source content item “http://xxxx.xxx.xxx” of a link type selected in the shared source screen, which is a web address. The target object 418 corresponds to a source content item “xxxx@xxx.xxx” of a link type selected in the shared source screen, which is an email address. A text box 422 contains an interactive content item “Perform data analysis” which corresponds to the target object 412. A text box 424 contains an interactive content item “Completed a project report” which corresponds to the target object 414. A text box 426 contains an interactive content item “http://xxxx.xxx.xxx” which corresponds to the target object 416. A text box 428 contains an interactive content item “xxxx@xxx.xxx” which corresponds to the target object 418.

A presentation example 420 in which the shared screen image 410 and the text boxes 422 to 428 are simultaneously presented is shown in the lower part of FIG. 4. In the presentation example 420, the text box 422 covers the target object 412, the text box 424 covers the target object 414, the text box 426 covers the target object 416, and the text box 428 covers the target object 418. Although the presentation example 420 is visually identical or similar to the shared screen image 410, the target objects 412 to 418 have been covered by the text boxes 422 to 428, respectively. Accordingly, the screen sharing recipient may perform interaction operations on the interactive content items in the text boxes 422 to 428.

It should be understood that although the text boxes 422 to 428 are shown as having a pattern background in FIG. 4, this is only for the ease of explanation. In an actual scenario, the text boxes 422 to 428 may have a transparent background, thus the existence of the text boxes 422 to 428 in the presentation example 420 will not be visually recognized. Accordingly, the presentation example 420 will be visually identical to the shared screen image 410. Moreover, it should be understood that all the elements shown in FIG. 4 are exemplary, and the embodiments of the present disclosure are not limited to any details in FIG. 4.

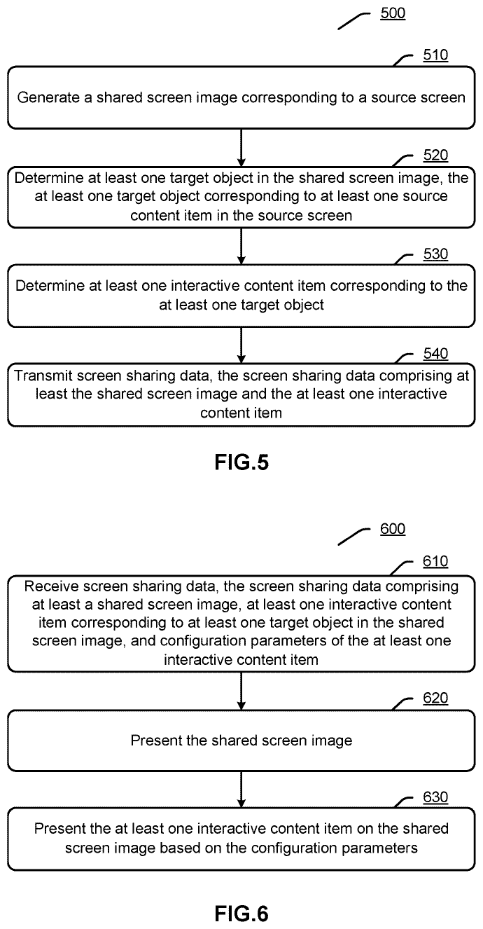

FIG. 5 illustrates a flowchart of an exemplary method 500 for providing interactive content in screen sharing according to an embodiment.

At 510, a shared screen image corresponding to a source screen may be generated.

At 520, at least one target object in the shared screen image may be determined, the at least one target object corresponding to at least one source content item in the source screen.

At 530, at least one interactive content item corresponding to the at least one target object may be determined.

At 540, screen sharing data may be transmitted, the screen sharing data comprising at least the shared screen image and the at least one interactive content item.

In an implementation, the determining at least one target object may include: receiving a selecting operation to the at least one source content item in the source screen; and determining the at least one target object based on the selecting operation.

In an implementation, the determining at least one interactive content item may include at least one of: obtaining the at least one source content item through executing a predetermined code segment with an API hook, and taking the at least one source content item as the at least one interactive content item; obtaining the at least one source content item through accessing an application associated with the at least one source content item, and taking the at least one source content item as the at least one interactive content item; and obtaining the at least one interactive content item through performing optical character recognition to the at least one target object.

In an implementation, the method 500 may further include: determining configuration parameters of the at least one interactive content item. The screen sharing data may further include the configuration parameters.

The determining configuration parameters of the at least one interactive content item may include: determining a display parameter of at least one text box corresponding to the at least one interactive content item, the display parameter at least enabling the at least one text box to cover the at least one target object.

The determining configuration parameters of the at least one interactive content item may include: determining an interaction property of the at least one interactive content item, the interaction property comprising at least one of a clickable property, a copy property and an editable property.

The determining an interaction property of the at least one interactive content item may include: receiving a setting operation to an interaction property of the at least one source content item; and determining the interaction property of the at least one interactive content item based on the setting operation.

In an implementation, the at least one interactive content item may be a text segment or a link.

In an implementation, the screen sharing may be performed by an application having a screen sharing function.

It should be understood that the method 500 may further include any other steps/processes for providing interactive content in screen sharing according to the embodiments of the present disclosure as described above.

FIG. 6 illustrates a flowchart of an exemplary method 600 for providing interactive content in screen sharing according to an embodiment.

At 610, screen sharing data may be received, the screen sharing data comprising at least a shared screen image, at least one interactive content item corresponding to at least one target object in the shared screen image, and configuration parameters of the at least one interactive content item.

At 620, the shared screen image may be presented.

At 630, the at least one interactive content item may be presented on the shared screen image based on the configuration parameters.

In an implementation, the configuration parameters may include a display parameter of at least one text box corresponding to the at least one interactive content item. The presenting the at least one interactive content item may include: presenting the at least one text box on the shared screen image based on the display parameter, wherein the at least one text box contains the at least one interactive content item, and the at least one text box covers the at least one target object.

In an implementation, the configuration parameters may include an interaction property of the at least one interactive content item. The method 600 may further include: setting the interaction property to the at least one interactive content item.

The interaction property may include at least an editable property. The method 600 may further include: obtaining at least one updated interactive content item produced by an editing operation to the at least one interactive content item; and transmitting the at least one updated interactive content item.

It should be understood that the method 600 may further include any other steps/processes for providing interactive content in screen sharing according to the embodiments of the present disclosure as described above.

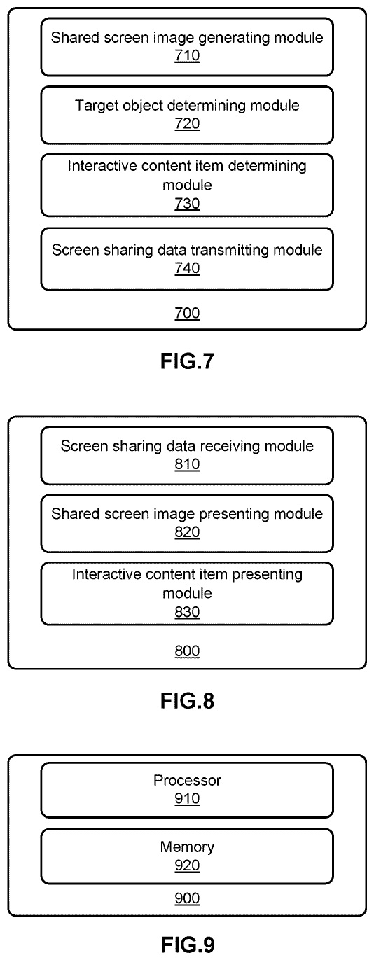

FIG. 7 illustrates an exemplary apparatus 700 for providing interactive content in screen sharing according to an embodiment.

The apparatus 700 may include: a shared screen image generating module 710, for generating a shared screen image corresponding to a source screen; a target object determining module 720, for determining at least one target object in the shared screen image, the at least one target object corresponding to at least one source content item in the source screen; an interactive content item determining module 730, for determining at least one interactive content item corresponding to the at least one target object; and a screen sharing data transmitting module 740, for transmitting screen sharing data, the screen sharing data comprising at least the shared screen image and the at least one interactive content item. Moreover, the apparatus 700 may further include any other modules configured to perform any steps/processes of the methods for providing interactive content in screen sharing according to the embodiments of the present disclosure as described above.

FIG. 8 illustrates an exemplary apparatus 800 for providing interactive content in screen sharing according to an embodiment.

The apparatus 800 may include: a screen sharing data receiving module 810, for receiving screen sharing data, the screen sharing data comprising at least a shared screen image, at least one interactive content item corresponding to at least one target object in the shared screen image, and configuration parameters of the at least one interactive content item; a shared screen image presenting module 820, for presenting the shared screen image; and an interactive content item presenting module 830, for presenting the at least one interactive content item on the shared screen image based on the configuration parameters. Moreover, the apparatus 800 may further include any other modules configured to perform any steps/processes of the methods for providing interactive content in screen sharing according to the embodiments of the present disclosure as described above.

FIG. 9 illustrates an exemplary apparatus 900 for providing interactive content in screen sharing according to an embodiment.

The apparatus 900 may include at least one processor 910. The apparatus 900 may further include a memory 920 connected with the at least one processor 910. The memory 920 may store computer-executable instructions. In an aspect, the computer-executable instructions, when executed, may cause the at least one processor 910 to: generate a shared screen image corresponding to a source screen; determine at least one target object in the shared screen image, the at least one target object corresponding to at least one source content item in the source screen; determine at least one interactive content item corresponding to the at least one target object; and transmit screen sharing data, the screen sharing data comprising at least the shared screen image and the at least one interactive content item. In another aspect, the computer-executable instructions, when executed, may cause the at least one processor 910 to: receive screen sharing data, the screen sharing data comprising at least a shared screen image, at least one interactive content item corresponding to at least one target object in the shared screen image, and configuration parameters of the at least one interactive content item; present the shared screen image; and present the at least one interactive content item on the shared screen image based on the configuration parameters. Moreover, the at least one processor 910 may be further configured to perform any other steps/processes of the methods for providing interactive content in screen sharing according to the embodiments of the present disclosure as described above.

The embodiments of the present disclosure propose computer program products for providing interactive content in screen sharing, comprising a computer program that is executed by at least one processor for performing any steps/processes of the methods for providing interactive content in screen sharing according to the embodiments of the present disclosure as described above.

The embodiments of the present disclosure may be embodied in a non-transitory computer-readable medium. The non-transitory computer readable medium may include instructions that, when executed, cause one or more processors to perform any steps/processes of the methods for providing interactive content in screen sharing according to the embodiments of the disclosure as described above.

It should be appreciated that all the operations in the methods described above are merely exemplary, and the present disclosure is not limited to any operations in the methods or sequence orders of these operations, and should cover all other equivalents under the same or similar concepts.

In addition, the articles “a” and “an” as used in this description and appended claims, unless otherwise specified or clear from the context that they are for the singular form, should generally be interpreted as meaning “one” or “one or more.”

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented as a microprocessor, a microcontroller, a digital signal processor (DSP), a field programmable gate array (FPGA), a programmable logic device (PLD), state machine, gate logic, discrete hardware circuitry, and other suitable processing components configured to perform the various functions described in this disclosure.

The functions of a processor, any portion of a processor, or any combination of processors presented in this disclosure may be implemented as software executed by a microprocessor, a microcontroller, a DSP, or other suitable platforms.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although a memory is shown as being separate from the processor in various aspects presented in this disclosure, a memory may also be internal to the processor (e.g., a cache or a register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are intended to be encompassed by the claims.

1. A method for providing interactive content in screen sharing, comprising:
generating a shared screen image corresponding to a source screen;
determining at least one target object in the shared screen image, the at least one target object corresponding to at least one source content item in the source screen;
determining at least one interactive content item corresponding to the at least one target object; and
transmitting screen sharing data, the scree sharing data comprising at least the shared screen image and the at least one interactive content item.

2. The method of claim 1, wherein the determining at least one target object comprises:
receiving a selecting operation to the at least one source content item in the source screen; and
determining the at least one target object based on the selecting operation.

3. The method of claim 1, wherein the determining at least one interactive content item comprises at least one of:
obtaining the at least one source content item through executing a predetermined code segment with an API hook, and taking the at least one source content item as the at least one interactive content item;
obtaining the at least one source content item through accessing an application associated with the at least one source content item, and taking the at least one source content item as the at least one interactive content item; and
obtaining the at least one interactive content item through performing optical character recognition to the at least one target object.

4. The method of claim 1, further comprising:
determining configuration parameters of the at least one interactive content item, and
the screen sharing data further comprises the configuration parameters.

5. The method of claim 4, wherein the determining configuration parameters of the at least one interactive content item comprises:
determining a display parameter of at least one text box corresponding to the at least one interactive content item, the display parameter at least enabling the at least one text box to cover the at least one target object.

6. The method of claim 4, wherein the determining configuration parameters of the at least one interactive content item comprises:
determining an interaction property of the at least one interactive content item, the interaction property comprising at least one of a clickable property, a copy property and an editable property.

7. The method of claim 6, wherein the determining an interaction property of the at least one interactive content item comprises:
receiving a setting operation to an interaction property of the at least one source content item; and
determining the interaction property of the at least one interactive content item based on the setting operation.

8. The method of claim 1, wherein
the at least one interactive content item is a text segment or a link.

9. The method of claim 1, wherein
the screen sharing is performed by an application having a screen sharing function.

10. A method for providing interactive content in screen sharing, comprising:
receiving screen sharing data, the screen sharing data comprising at least a shared screen image, at least one interactive content item corresponding to at least one target object in the shared screen image, and configuration parameters of the at least one interactive content item;
presenting the shared screen image; and
presenting the at least one interactive content item on the shared screen image based on the configuration parameters.

11. The method of claim 10, wherein the configuration parameters comprise a display parameter of at least one text box corresponding to the at least one interactive content item, and the presenting the at least one interactive content item comprises:
presenting the at least one text box on the shared screen image based on the display parameter, wherein the at least one text box contains the at least one interactive content item, and the at least one text box covers the at least one target object.

12. The method of claim 10, wherein the configuration parameters comprise an interaction property of the at least one interactive content item, and the method further comprises:
setting the interaction property to the at least one interactive content item.

13. An apparatus for providing interactive content in screen sharing, comprising:
at least one processor; and
a memory storing computer-executable instructions that, when executed, cause the at least one processor to:
generate a shared screen image corresponding to a source screen,
determine at least one target object in the shared screen image, the at least one target object corresponding to at least one source content item in the source screen,
determine at least one interactive content item corresponding to the at least one target object, and
transmit screen sharing data, the screen sharing data comprising at least the shared screen image and the at least one interactive content item.
